(19) United States
(12) Patent Application Publication
(10) Pub. No.: US 2009/0320390 A1
(43) Pub. Date: Dec. 31, 2009

(54) Insulation kit for pet enclosure

(75) Inventors: Kevin L. Kolozsvari, Cowan Heights, CA (US); Anita H. Abernathy, Villa Park, CA (US)

Correspondence Address: STETINA BRUNDA GARRED & BRUCKER, 75 ENTERPRISE, SUITE 250, ALISO VIEJO, CA, 92656, US

(73) Assignee: Precision Pet Products

(21) Appl. No.: 12/215,788

(22) Filed: Jun. 30, 2008

(51) Int. Cl. E06B 3/263

(52) U.S. Cl. 52/202; 119/482

(57) ABSTRACT

There is provided an insulation kit for a pet enclosure such as a doghouse. The insulation kit provides insulation to the doghouse to foster a comfortable and safe environment for dogs. The insulation kit is advantageously configured for easy transport and storage, and is a low cost alternative to current insulation kits on the market. The insulation kit includes a base panel that is positioned on the floor of the pet enclosure. In addition, the insulation kit includes a plurality of side panels that are positioned around the walls in the interior of the pet enclosure. Each side panel includes a plurality of connector members disposed about the outer periphery of the side panel for pivotally connecting onto the base panel to provide for a pivotal collapse of the side panel onto the base panel. The connector members further pivotally interconnect the side panel to adjacent side panels to provide for pivotal folding of the interconnected side panels. As a result, the interconnected side panels and base panel create a thermal shell that provides a layer of insulation to the interior of the pet enclosure. It is contemplated that the insulation kit is constructed of die cut foam panels that encourage a lightweight and low cost mass production.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates to an insulation kit for a pet enclosure, and more particularly to a collapsible insulation kit for a pet enclosure that is mass produced from die cut foam and capable of being expandable in size.

2. Description of the Related Art

Pet owners have a special relationship with their pets. This special relationship encourages pet owners to create comfortable environments that cater to their beloved pets. In this regard, Americans spent an estimated $40.8 billion on their pets last year according to the American Pet Products Manufacturers Association. People are lavishing that money on a pet population that includes 74.8 million dogs. It's a financial commitment that shows that pets have become full-fledged members of the family.

As such, many pet owners keep their dogs in the comfort of their home. However, most dogs generally prefer spending a great deal of time outdoors. Therefore, pet owners often utilize outdoor pet enclosures to provide their dogs with outdoor living while still providing comfortable shelter.

A doghouse is a small shed commonly built in the shape of a little house intended for a dog. It is a structure in which a dog is kept or can run into for shelter from the elements. A doghouse should not be too big or too small for the intended dog because of the potential for excessive heat loss or excessive constriction. Pet owners often furnish doghouses with requisite items to provide comfort for their pets. In this regard, beds, food, water dishes, and toys are routine items one would regularly find in a doghouse.

Additionally, doghouses are often constructed in a manner so that they are aesthetically pleasing while also being insulated and ventilated. The construction methods often employed to construct doghouses often vary depending on locale. In this regard, in routinely warm and dry climates it is critical to construct a doghouse such that it is sufficiently ventilated. Likewise, in cold and wet climates it is critical to construct a doghouse with adequate insulation to provide the dog with warmth and comfort. Pet owners oftentimes insulate a doghouse after purchasing or building it. Commercial insulation kits are currently present in the market. It is important that such insulation kits are easy to assemble, low cost, and easy to transport. Additionally, most manufacturers of pet products would prefer to keep shipping and storage costs low by developing insulation kits that are capable of collapsing or folding into convenient marketable packages that consumers may purchase at department stores or pet specialty stores.

Currently, there are insulation kits in the market that utilize wooden planks to insulate a doghouse. In this regard, the wooden planks are sized to be employed in the interior space of the doghouse and positioned against the interior doghouse walls. However, wooden planks are plagued with a multitude of problems. Wooden planks are susceptible to the elements they are intended to insulate the dog from. In this regard, wooden planks may rot as a result of being exposed to moisture. Additionally, wooden planks are difficult to transport and lack commercial viability as they are difficult to market due to their large size and weight. Furthermore, if a pet owner decides to purchase a new doghouse for their dog, they would be unable to utilize the same wooden plarks to insulate the new doghouse, as they would not fit the specifications of the new doghouse. Additionally, wooden planks do not provide any additional comfort to the dog.

Other insulation kits in the market include zip lined leather kits that are configured to attach to the interior of a doghouse via a zipper. However, these kits have similar problems as wooden planks do, notably that they are not expandable in size. In this regard, for a pet owner to utilize a zip lined kit in a new doghouse, the pet owner must remove the zipper, sew additional leather to the lining in accordance with the dimensional specifications of the new doghouse. Subsequently, the pet owner must reattach the zipper and adapt the new doghouse so that the insulation kit may be outfitted accordingly. Despite this being a tedious process for the pet owner, the zipper attachment significantly increases the manufacturing costs associated with the kit. Additionally, the zip lined kit requires a lengthy and meticulous manual manufacturing process as a result of sewing the zipper to the lining. As such, the zip lined kit is difficult to mass produce at a low cost.

Therefore, there is a need in the art for an improved insulation kit for pet enclosures.

### BRIEF SUMMARY

In accordance with the present invention, there is provided multiple embodiments of an insulation kit for a pet enclosure such as a doghouse. The insulation kit provides insulation to the doghouse to foster a comfortable and safe environment for dogs. The insulation kit is advantageously configured for easy transport and storage, and is a low cost alternative to current insulation kits on the market. In a basic embodiment of the present invention, the insulation kit includes a base panel that is positioned on the floor in the interior of the pet enclosure. In addition, the insulation kit includes a plurality of side panels that are positioned around the walls in the interior of the pet enclosure. Each side panel includes a body and a plurality of connector members disposed about the outer periphery of the side panel for pivotally connecting onto the base panel to provide for a pivotal collapse of the side panel onto the base panel. In this regard, the insulator kit is advantageously designed for easy storage and transport.

Additionally, the connector members pivotally interconnect the side panel to adjacent side panels to provide for pivotal folding of the interconnected side panels. As a result, the interconnected side panels and base panel create a thermal shell that provides a layer of insulation to the interior of the pet enclosure. In addition, the foldable and collapsible nature of the panels allow for the kit to be stacked in a collapsed position for ease in transport or storage during warmer months. The insulation kit further includes at least one side panel that has an opening for ingress and egress of the dog. It is further contemplated that the side panels and the base panel are constructed from material that is relatively light in weight. Therefore, the side panels and base panel may be fabricated from die cut foam. The die cut aspect of the construction fosters lower costs in mass production as well.

In a preferred embodiment of the present invention, the connector members of the side panels and the base panel may be male/female connectors such as tongue in cheek connectors or dovetail connectors or the like. In an alternative embodiment of the present invention, the side panels may be pivotally interconnected with an adhesive or Velcro® strips or the like. Alternatively, the side panels may be pivotally interconnected with metal hinges and fasteners or the like.

In a preferred embodiment of the present invention, the side panels and the base panels of the insulation kit may be fabricated from polyethylene foam. It is contemplated that the polyethylene foam may be open celled or closed celled. It is further contemplated that the side panels and base panel may be configured so they range from ¼ inch to 1¼ inches in thickness. Additionally, it is further contemplated that the polyethylene foam may utilize a barrier material, such as ethyl vinyl alcohol resin or the like, to protect the side panels and base panel from excessive moisture. In a preferred embodiment, the polyethylene foam may be self-skinned so that the outer skin of the side panels and the base panel is rigid while the interior of the panels remains soft thereby creating a comfortable cushion for the pet. The rigidity of the exterior of the panels will provide a level of durability to withstand rough use by the pet and exposure to natural elements from being outdoors. It is contemplated that the insulation kit of the present invention provides an increased R-factor of up to three to four times over a doghouse without any insulation.

In an alternative embodiment of the present invention, the insulation kit may come with a top panel having a plurality of connector members disposed about its outer periphery for pivotally interconnecting with the side panels. The top panel may be positioned under the roof of the pet enclosure to provide further insulation. It is contemplated that the insulation kit may be expandable in size by interconnecting additional panels to the side panels and base panel. In this regard, the pet owner may utilize the existing insulation kit for new doghouses by adjusting the size of the insulation kit accordingly. Oftentimes a pet owner may purchase a new pet enclosure when a puppy matures into an adult dog to accommodate the larger size. The insulation kit allows the pet owner to adapt the existing kit to the new pet enclosure rather than purchasing an entirely new kit. It is further contemplated that the side panels and the base panel may be stacked upon each other when not connected in a convenient package providing for easy transport, storage, and commercial appeal.

As will be appreciated, in addition to the convenience and optimal insulation aspects of the present invention, there is further provided an insulation kit which is environmentally friendly and is fabricated without any toxic materials that may harm a pet.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a pet enclosure, an Outback Log Cabin doghouse, outfitted with an insulation kit in accordance with the present invention.

FIG. 2 illustrates an alternative view of the pet enclosure depicting a base panel and side panels positioned relative to the floor and side walls of the pet enclosure.

FIG. 3 illustrates an insulation kit where the side panels are interconnected to adjacent side panels via connector members and the side panels are pivotally connected to the base panel via the connector members.

FIG. 4 illustrates an exploded of the insulation kit depicting the side panels and a base panel, where one side panel has an opening for ingress and egress for a pet.

Common reference numerals are used throughout the drawings and detailed description to indicate like elements.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

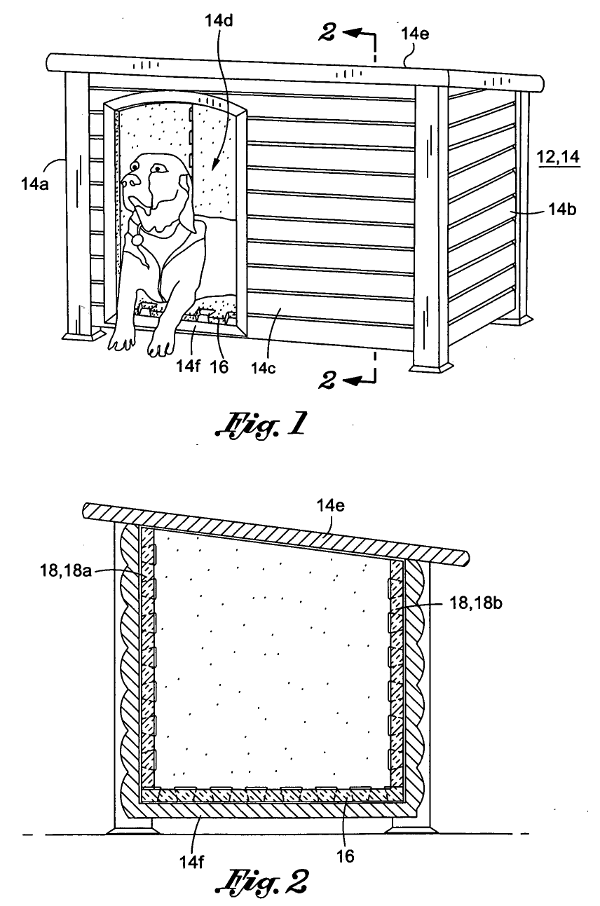

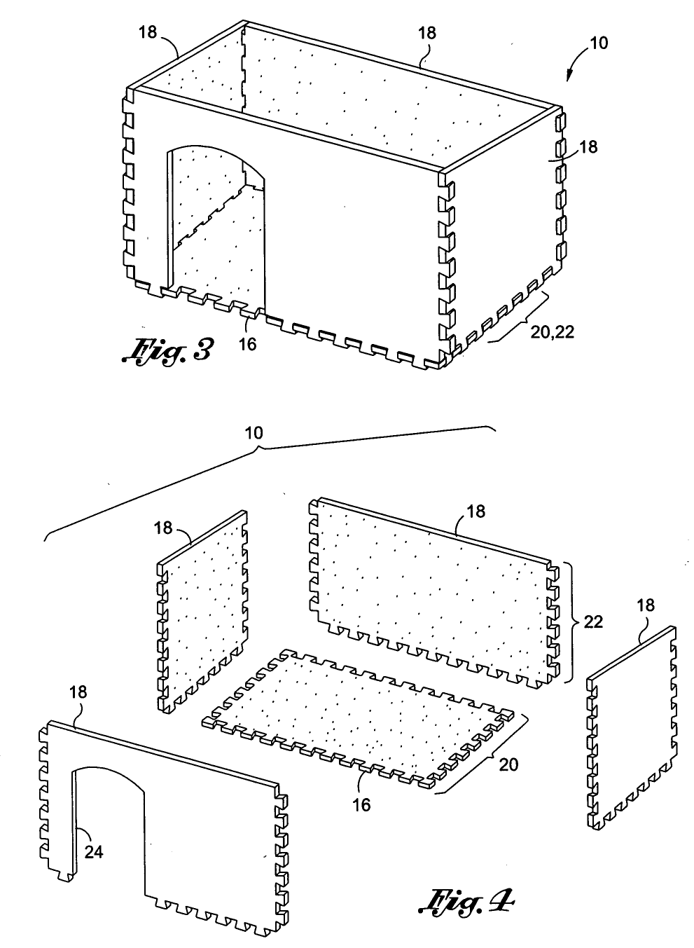

FIGS. 1-4 provide an insulation kit 10 configured in accordance with the present invention. An insulation kit 10 provides a thermal insulation layer to a pet enclosure to foster a comfortable and safe environment for pets. In this regard, the insulation kit 10 may be adapted to be employed in a variety of pet enclosures 12 such as a doghouse or the like. In the present embodiment, the pet enclosure is a medium Outback Log Cabin 14 manufactured by Precision Pet Products. The Outback Log Cabin 14 is incorporated by reference herein in its entirety. A person having ordinary skill in the art would understand that the Outback Log Cabin 14 is presented as an exemplary pet enclosure 12 in which an insulation kit 10 may be outfitted and in no way serves to limit the present invention. In this regard, a person having ordinary skill in the art would recognize that any pet enclosure 12, taking a variety of shapes and sizes, may be outfitted with an insulation kit 10 in accordance with the present invention. The interior dimensions of a medium Outback Log Cabin are 40L×21W×19.5H. In the present embodiment, the insulation kit 10 is configured in accordance to the dimensions of the Outback Log Cabin 14. The Outback Log Cabin 14 is a rigidly constructed doghouse intended to be affixed outdoors to provide a pet with comfortable shelter. The Outback Log Cabin 14 has a left side wall 14a, a right side wall 14b, a front side wall 14c having an opening 14d for ingress and egress for a canine, a rear side wall (not pictured), a roof 14e, and a base floor 14f.

In a basic embodiment of the present invention, the insulation kit 10 includes a base panel 16 that is positioned on the base floor 14f in the interior of the Outback Log Cabin. The base panel 16 includes a plurality of connector members 20 disposed about its outer periphery. In addition, the insulation kit 10 includes a plurality of side panels 18 that are positioned around the side walls 14a-14c in the interior space of the Outback Log Cabin 14. In the present invention, the insulation kit 10 includes four side panels 18 sized in accordance to complement the four side walls of the Outback Log Cabin 14. Each side panel 18 includes a body and a plurality of connector members 22 disposed about the outer periphery of the side panel 18 for pivotally connecting onto the base panel 16 to provide for a pivotal collapse of the side panel 18 onto the base panel 16. In this regard, the side panel connector members 22 are sized and configured to be cooperatively engaged with the base panel connector members 20. Therefore, the insulator kit 10 is advantageously designed for easy storage and transport. Additionally, the collapsible nature of the base panel 16 and side panels 18 facilitates the insulation kit 10 to be conveniently packaged for commercial sale.

Additionally, the connector members 22 of the side panel pivotally interconnect the side panel 18 to adjacent side panels 18 to provide for pivotal folding of the interconnected side panels and rigid structural support for the insulation kit 10. As a result, the interconnected side panels 18 and base panel 16 provide a shell that serves as a layer of thermal insulation to the Outback Log Cabin 14. In addition, the foldable and collapsible nature of the panels 16, 18 allow for the kit to be stacked in a collapsed position for easy transport and storage during warmer months. The insulation kit 10 further includes at least one side panel 18 that has an opening 24 for ingress and egress of a pet. It is contemplated that a pet enclosure 12 may utilize more than opening for pets to easily ingress and egress. In the present embodiment, an Outback Log Cabin 14 has one such opening 14d positioned in the front sidewall 14c. The opening 14d in the Outback Log Cabin is sized at 18.7H×14.2W. In this regard, one side panel 18 has a corresponding opening 24 relative in size. However, a person having ordinary skill in the art will understand that the side panel opening 24 may be configured at any dimension relative to the opening of any pet enclosure so that the pet may utilize the pet enclosure as intended.

It is further contemplated that the side panels 18 and the base panel 16 are fabricated from material that is lightweight such as foam or the like. In the present embodiment, the side panels 18 and base panel 20 are fabricated from die cut foam. A die is a specialized tool used in manufacturing industries to cut, shape and form a wide variety of products and components. Like molds and templates, dies are generally customized and uniquely matched to the product they are used to create. As a result, mass produced die cut foam is a low cost alternative to current insulation kits on the market.

In a preferred embodiment of the present invention, the connector members 20, 22 of the side panels and the base panel may be male/female connectors such as tongue in cheek connectors or dovetail connectors or the like. In the present embodiment, the connector members 20, 22 are dovetail connectors. A person having ordinary skill in the art will understand that any attachment connector that provides a pivotal connection between the panels such as Velcro®, hinges and fasteners, adhesives or the like may be utilized in the present invention. However, the cost of utilizing dovetail connections is relatively inexpensive as compared to the alternative means. In this regard, the foam panels are mass-produced with the dovetail connections on the panels. A die that is specially designed in accordance with the dimensions of the dovetail connections facilitates the mass production of the insulation kit 10. Additionally, the lightweight construction of the kit along with the dovetail connections allows the pet owner to easily assemble and dissemble the insulation kit. The dovetail connections requires the use of minimal to none additional tools for assembly allowing the pet owner to take advantage of a rigidly constructed insulation kit with easy assembly.

The insulation foam provided by the present invention provides a thermal layer to insulate the pet enclosure 12 and cushion like support to provide comfort to the pet. Thermal insulation may be measured by an R-factor. An R-factor of a surface determines how quickly heat is conducted across it. It is contemplated that the insulation kit 10 in accordance with the present invention provides an increased R-factor of up to three to four times over a pet enclosure 12 without any insulation. In a preferred embodiment of the present invention, the side panels 18 and base panel 16 are configured so they range from ¼ and 1¼ inches in thickness. In the present embodiment, the side panels and base panel are configured to be ⅜ inch thick.

In a preferred embodiment of the present invention, the side panels 18 and base panel 16 are fabricated from foam such as polyethylene or urethane or the like. In the present embodiment, the side panels 18 and base panel 16 are fabricated from polyethylene foam. Polyethylene foam is made up of larger chains of ethylene and has molecular weight in the millions. As a result, these chains stick together through weak Van der Waals forces, therefore the material is pliable and soft providing additional comfort to the pet. Additionally, polyethylene foam is buoyant, non-abrasive, and serves as a good thermal insulator.

Furthermore, polyethylene foam is inert to water, grease and solvents at typical temperatures and is tear-resistant. As a result, the insulation kit 10 can withstand the rigors of daily pet activity. However, the insulation kit 10 is advantageously designed so that its cost is low and easy to assemble, therefore a pet owner may easily replace the insulation kit 10 if it begins to wear over time. A pertinent trait of an insulation kit is that it provides comfort to the pet. In this regard, polyethylene foam is soft and also odorless. Certain pets are susceptible to smells and sounds that significantly irritate them. As such, it is critical to utilize materials that are pleasant to the pet or in the alternative, odorless. In order to protect the safety of pets, it is critical that pet enclosures are not constructed in a manner that may expose a pet to toxic or harmful materials. As such, pets have a tendency to bite, chew, and scratch materials they come in contact with. Therefore, toxins should not be utilized regardless of their order within the construction of pet products. In this regard, polyethylene foam is resistant to bacteria and is approved for use in the food industry. As a result, the insulation kit 10, as utilized in a pet enclosure 12, does not pose any threat to the pet. Moreover, polyethylene foam is also environmentally friendly by being CFC-free, ozone friendly, and recyclable.

It is contemplated that the polyethylene foam may be open celled or closed celled. Open-cell foam is soft, similar to a cushion. As such, the cell walls are broken so that air fills all of the spaces in the material. As a result, the foam is softer or weaker. The insulation value of open-cell foam is related to the insulation value of the calm air inside the matrix of broken cells. The densities of open-cell foams are around ½ to ¾ of a pound per cubic foot. Alternatively, closed-cell foam has varying degrees of hardness or rigidity, depending on its density. Conventional closed-cell insulation foam is between 2 and 3 pounds per cubic foot. In this regard, it is strong enough to walk on without major distortion. Therefore, most of the cells in the foam are not broken. As a result, the foam is strong or rigid because the bubbles are strong enough to take a lot of pressure.

Closed cell foam is generally stronger than open-cell foam. In addition, closed-cell foam has a greater R-factor and greater resistance to leakage of air than open-cell foam. Thus, closed cell polyethylene foam may be more advantageous to be outfitted in pet enclosures 12 that provide shelter for larger, heavier, or multiple dogs. Additionally, closed-cell foam is advantageous to be employed in environment with harsher colder climates. However, closed-cell foam is also denser, requiring more material, and therefore more expensive that open-cell foam. As a result, it is contemplated that the present invention may employ either open-cell or closed-cell foam depending upon strength, climate, the size and number of pets and expense relative to the requisite needs of the intended pet and pet owner.

It is further contemplated that the side panels 18 and base panel 16 may utilize barrier material such as ethyl vinyl alcohol resin or the like to protect it from moisture and environmental conditions. In the present embodiment, the side panels 18 and base panel 16 are treated with ethyl vinyl alcohol resin to provide an oxygen barrier to the foam. As such, the insulation kit 10 is advantageously designed to endure prolonged exposure to the elements of nature, such as snow, humidity, and rain. Ethyl vinyl alcohol resin is hydroscopic thus it absorbs moisture. The amount of moisture absorbed and the speed of absorption will depend upon the environmental conditions encountered. Additionally, moisture absorption is dependent upon temperature and the relative humidity of the environment. Therefore, it is contemplated that the insulation kit 10 will be treated with the appropriate amount and type of barrier material relative to the climate of the environment it will be used in.

In the present embodiment, the side panels 18 and base panel 16 are self skinned so that the outer skin of the side panels 18 and the base panel 16 are rigid while the interior is soft. Providing a rigid outer skin on the panels 16, 18 is advantageous since pets may claw, scratch, or bite the panels 16, 18. In this regard, self skinned foam consists of high-density skin foam and low density core foam. The soft low density foam is sandwiched between the high density foam creating a soft core while retaining a durable and rigid outer skin. The rigidity of the exterior of the panels will provide a level of durability to withstand rough use by the pet and exposure to natural elements from being outdoors.

Many pet enclosures 12 are designed in light of the natural conditions surrounding the environments they are placed in. In the present embodiment the Outback Log Cabin has a slanted roof 14e to channel rain or snow off the roof, as illustrated in FIG. 2. As such, the side walls of the Outback Log Cabin are sized to accommodate the slanted roof 14e. Therefore, the side panels 18a, 18b are sized in accordingly to fit the side walls of the roofed cabin. Additionally, it is contemplated that the insulation kit 10 may include a top panel having a plurality of connector members disposed about its outer periphery for pivotally interconnecting with the side panels. The top panel (not pictured) may be positioned under the roof 14e of the pet enclosure 12 to provide further insulation. It is contemplated that the top panel may be configured to come in a variety of shapes and forms to accommodate the specifications of the roof 14e, such as a slanted roof or the like.

Pet owners may require new pet enclosures 12 upon procuring additional pets whom intend to share the same enclosure, or if the puppy grows into a larger mature adult dog, or for simply providing a change for their pet. In this regard, it is contemplated that the side panels 18 and base panel 16 may be expandable in size by interconnecting additional panels to the side panels 18 and base panel 16. Therefore, the pet owner may utilize existing insulation kits 10 for new pet enclosures 12 by adjusting the size of the insulation kit 10 accordingly. It is further contemplated that the side panels 18 and the base panel 16 may be stacked upon each other when not connected in a convenient package providing easy transport, storage, and commercial appeal. In this regard, the insulation kit 10 may be marketed to consumers in department stores or pet specialty stores. The lightweight construction of the insulation kit 10 and the ability to fold and stack the panels 16, 18 together provides the pet owner with the versatility to utilize the insulation kit 18 in colder weather while storing the kit in warmer weather.

As will be appreciated, in addition to the convenience and optimal insulation aspects of the present invention, there is further provided an insulation kit 10 which is environmentally friendly and is fabricated without any toxic materials that may harm a pet

The particulars shown herein are by way of example and for the purpose of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art bow the several forms of the present invention may be embodied in practice.

What is claimed is:

1. An insulation kit for a pet enclosure, the insulation kit comprising:
a base panel fabricated from die cut foam, the base panel having a base outer periphery and a plurality of base connector members disposed about the base outer periphery;
a plurality of side panels fabricated from die cut foam, each side panel having a body and a side outer periphery;
a plurality of side connector members disposed about the side outer periphery, the side connector members being sized and configured to cooperatively engage with the base connector members to provide for pivotal collapse of the side panels onto the base panel;
the side connector members being sized and configured to cooperatively engage with the side connector members of adjacent side panels to pivotally interconnect the side panels to adjacent side panels and provide for pivotal folding of the interconnected side panels; and
at least one side panel has an opening in the body for ingress and egress of a pet.

2. The insulation kit of claim 1, wherein the insulation kit has four side panels configured to thermally layer the side walls of a pet enclosure.

3. The insulation kit of claim 1, wherein the side and base connector members are dovetail connectors so that the side panels are pivotally interconnected to adjacent side panels and the base panel by dovetail connections.

4. The insulation kit of claim 1, wherein the side panels and the base panel are ¼ inch to 1¼ inch thick.

5. The insulation kit of claim 1, wherein the side panels and the base panel are expandable in size by interconnecting additional panels to the side panels and the base panel.

6. The insulation kit of claim 1, wherein the insulation kit further comprises a top panel having an outer periphery including a plurality of top connector members disposed about the outer periphery of the top panel for pivotally interconnecting with the side panels.

7. The insulation kit of claim 6, wherein the top panel is configured to thermally layer the roof of the pet enclosure.

8. The insulation kit of claim 1, wherein the side panels and base panel are coated with an ethyl vinyl alcohol resin oxygen barrier.

9. The insulation kit of claim 1, wherein the side panels and base panel are fabricated from polyethylene foam.

10. The insulation kit of claim 9, wherein the polyethylene foam is open celled.

11. The insulation kit of claim 9, wherein the polyethylene foam is closed celled.

12. The insulation kit of claim 9, wherein the polyethylene foam is self skinned so that the outer skin of the side panels and the base panel is rigid.

13. The insulation kit of claim 1, wherein the side panels and base panel include Velcro® strips to pivotally interconnect the side panels to adjacent side panels and the base panel.

14. The insulation kit of claim 1, wherein the side panels and base panel include metal hinges and fasteners to pivotally interconnect the side panels to adjacent side panels and the base panel.

15. The insulation kit of claim 1, wherein the side panels and base panel include adhesive strips to pivotally interconnect the side panels to adjacent side panels and the base panel.
